(19) United States
(12) Patent Application Publication
(10) Pub. No.: US 2025/0311865 A1
(43) Pub. Date: Oct. 9, 2025

(54) CABINET WITH AIR CURTAIN

(71) Applicant: THE ALAN NUTTALL PARTNERSHIP LIMITED, Hinckley (GB)

(72) Inventor: Michael Steele, Hinckley (GB)

(21) Appl. No.: 18/866,740

(22) PCT Filed: May 17, 2023
(86) PCT No.: PCT/GB2023/051298

§ 371 Date: Nov. 18, 2024

(30) Foreign Application Priority Data
May 18, 2022 (GB) 2207258.1

(51) Int. Cl. A47F 3/04; A47F 10/06; A47J 39/00; A47J 39/02

(52) U.S. Cl. CPC A47F 3/0408; A47F 10/06; A47J 39/003; A47J 39/02

(57) ABSTRACT

A cabinet for storage of a heated food item has a base, top and opposing sides, the base, top and opposing sides defining an interior space which is accessible through opposing access apertures, An air movement means and air heating means draw air from the interior space of the cabinet, heat said air and produce an air curtain across a first one of the access apertures of the cabinet. A door is operable to reversibly close a second one of the access apertures to prevent ambient air from entering the interior space and heated air from egressing through said second access aperture. The air movement means circulate air within the interior space from the first one of the access apertures to one or more of: the opposing sides, and the top and the base of the cabinet.

### BACKGROUND

The present invention relates to a cabinet for the temporary storage of a heated food item. More specifically, the present invention relates to a cabinet for the temporary storage of a heated food item wherein the cabinet is operable to retard the cooling of the heated food item by the circulation of heated air over and around the food item.

Changes in working patterns have led to changes in eating habits particularly with respect to what might be called the traditional evening meal where a family sits around a table and eats home-cooked food. It is now becoming increasingly commonplace for convenience meals to be eaten in the evening while watching television from an easy chair. That has, in turn, led to an increase in take-away food outlets where a person can collect a hot ready-cooked meal to eat at home.

For some time, supermarkets have offered a range of prepared food which can be taken home, heated or cooked, and then eaten. However, there is now increasing competition from take-away food outlets which supermarkets would like to address by supplying hot ready-cooked meals themselves. One of the problems faced by supermarkets is how to keep such food hot whilst making it readily accessible to customers and an object of the present invention is to provide a cabinet which will be suitable for such a purpose.

In addition to the collection of food from supermarkets, there has also been an increase in the ordering of cooked food products via the internet for home delivery. Typically a consumer will utilise the services of an online food delivery business to have food from a consumer specified restaurant delivered to their home. Delivery to the consumer may be undertaken by delivery drivers or cyclists who collect the cooked food products from a kitchen. The kitchen may be the kitchen of a restaurant. Alternatively the kitchen may be dedicated to the provision of restaurant style cooked food products for home delivery.

The delivery drivers or cyclists are provided with apparatus such as insulated containers which retard the cooling of the cooked food products during the delivery phase, however there has been identified a need to retard the cooling of the cooked food products in the period after cooking and before collection by a delivery driver or cyclist.

It is known to provide a cabinet for the storage of a heated food item with air movement means and air heating means configured to produce an air curtain across an access aperture of the cabinet. Here the term “access aperture’ refers to an aperture of the cabinet which provides access to an internal space of the cabinet designed to receive the food item. For instance, the Applicant's published International Application Publication Number WO 2019/025822 discloses a cabinet having a base, a top and opposing sides. The base, top and opposing sides define an interior space of the cabinet which is accessible through opposing apertures at each end of the cabinet. The cabinet is provided with air movement means and air heating means operable to draw air from the interior space of the cabinet, heat said air and utilise a portion of said heated air to produce air curtains across the opposing apertures of the cabinet. The remainder of said air is circulated within the interior space of the cabinet.

The interior space is thus readily accessible through the apertures to allow a food item to be placed into and thereafter removed from the interior space. The heated air curtains allow the interior space of the cabinet to be maintained at an elevated temperature compared to the ambient temperature surrounding the cabinet.

Similarly, European Patent Publication Number EP 3804575 discloses a unit in which an air curtain is provided over an open front of a display unit for storing food products. The system of EP 3804575 is further provided with a number of shelves wherein at least one of the shelves is a hollow shelf with an inner space, a shelf air outlet at a front side, a shelf air inlet at a back side, a fan, and a shelf heater. The fan is in fluid connection with the shelf air inlet and the shelf air outlet for moving air from the shelf air inlet through the hollow shelf to the shelf air outlet. In this way, heated air is circulated between the front and back of the display unit. EP 3804575 further discloses that, in an embodiment, the air circulation system further comprises a lower back outlet at the lower air duct, and an upper back inlet at the upper air duct, and the lower back outlet is directed at the upper back inlet for creating a back air curtain in front of the back wall. The back wall comprises a back door over the back air curtain. In particular, the back door is a sliding door. The sliding door enables food products to be provided to the open front chamber from the back, i.e. from a side where no consumers are.

Nonetheless, workers operating in, for example, a kitchen and accessing the unit of EP 3804575 through the back wall are thus forced to place their hands through the hot back air curtain. This may be uncomfortable, particularly where the air flow must be heated to a high temperature to maintain suitable conditions for the food.

Further, the need for the user to actively slide the door closed after accessing the cabinet may be excessively cumbersome in some environments, for instance, high through-put quick service restaurants. In addition, there is a risk that workers will forget to close the door after access the unit, thus leaving the environment in the unit more exposed to external conditions than may be desirable.

The present invention seeks to address one or more of the aforementioned problems.

### SUMMARY

According to a first aspect of the present invention, there is provided a cabinet for the temporary storage of a heated food item, the cabinet having a base, a top and opposing sides, wherein the base, top and opposing sides define an interior space which is accessible through opposing access apertures at each end of the cabinet and wherein the cabinet is provided with air movement means and air heating means operable to draw air from the interior space of the cabinet, heat said air and utilise said heated air to produce an air curtain across a first one of the access apertures of the cabinet, the cabinet further comprising a door, the door being operable to reversibly close a second one of the access apertures to prevent ambient air from entering the interior space and heated air from egressing through said second one of the access apertures, wherein the air movement means are configured to circulate air within the interior space from the first one of the access apertures to one or more of: the opposing sides, and the top and the base of the cabinet.

In other words, the air movement means are configured to drive an airflow within the interior space in which air moves from the first one of the access apertures to one or more of the opposing sides and the top and the base of the cabinet. In some embodiments, this means that the air circulating within the interior space from the first one of the apertures to the one or more of the opposing sides, and the top and the base of the cabinet bypasses a region adjacent the second one of the access apertures.

Accordingly, the interior space is readily accessible through the apertures to allow a food item to be placed into and thereafter removed from the interior space. The heated air curtain allow the interior space of the cabinet to be maintained at an elevated temperature compared to the ambient temperature surrounding the cabinet.

The door provides a barrier to air flow into and out of the cabinet, thereby further retarding the cooling of the heated food product. The door also acts to provide a physical barrier to other undesirable objects, such as insects.

Unlike in known systems such as that disclosed in EP 3 804 575, in which air flow is drawn from an open front of the unit towards a back door, in the cabinet of the present invention, air moves from the first one of the apertures to one or more of: the opposing sides, and the top and the base of the cabinet, and not to the back of the cabinet (or the side opposing the open side).

Because the air flow generated by the air movement means generally avoids the region adjacent the second one of the access apertures, opening and closing of the door by the worker does not disturb the air flow within the interior space. Indeed, in some embodiments, air flow in the interior space is at a minimum in a region adjacent the second one of the access apertures. In EP 3 804 575, disruption of the air flow upon opening of the back door is addressed by providing an air curtain over the back of the unit. It will be appreciated that the solution provided by the present invention eliminates the need for this second air curtain, thus reducing the amount of energy needed to maintain optimum conditions in the cabinet.

Further, because air flow in the region of the second one of the access apertures is reduced, it is avoided that workers have to place their hand through a hot air flow to access the interior space, thus improving comfort for users and reduces the risk of burns.

In some embodiments, after moving through the interior space from the first one of the access apertures to the one or more of: the opposing sides, and the top and the base of the cabinet, the air thereafter exits the interior space and moves into a chamber located within the cabinet and either above or below the interior space. The air movement means may be configured to deliver the airflow from the chamber back to the first one of the access apertures to be thereafter circulated once again within the interior space to one or more of the opposing sides and the top and the base of the cabinet. In this way, air is repeatedly circulated by the air movement means between the first one of the access apertures and the one or more of: the opposing sides, and the top and the base of the cabinet via the internal space and the chamber.

In some embodiments, the air movement means are configured to draw air from the first one of the access apertures to the opposing sides. Optionally, the air movement means draw a first portion of the airflow from the first one of the access apertures to a first one of the opposing sides and a second portion of the airflow to a second one of the sides. In other words, air flow in the interior space May generally circulate between the first access aperture, or the region adjacent the first access aperture and the opposing sides. Optionally, the first and second portions are equal.

Optionally, the cabinet is provided with one or more inlet apertures which allow fluid communication between the interior space of the cabinet and the air movement means, further wherein the one or more inlet apertures are spaced from the second one of the access apertures. In other words, the inlet apertures are located away from the second one of the access apertures.

This is different from known cabinets, such as that disclosed in European Patent Application Publication Number EP 3 804 575, in which the shelf air inlet is provided at the back wall, adjacent the back door. Since the inlet apertures of the cabinet of the present invention are spaced from the second one of the access apertures, air in the interior space is not drawn towards the second one of the access apertures and air flow instead avoids the second one of the access apertures during circulation.

Optionally, the opposing sides of the cabinet comprise a first pair of opposing sides and the first access aperture and the second access aperture are each arranged along a respective one of a second pair of opposing sides of the cabinet, the second pair of opposing sides being arranged perpendicular to the first pair of opposing sides. Optionally, the inlet apertures are provided away from the second pair of opposing sides. That is, the cabinet may have no air inlet apertures at the second pair of opposing sides. Instead, the inlet apertures may be located along the first pair of opposing sides. Alternatively or additionally, there may be air inlet apertures located along a top wall of the interior space, or along a bottom wall of the interior space. Accordingly, air in the interior space being drawn towards the air movement means is drawn towards the inlet apertures along any of all of the first pair of opposing sides, the top wall of the cabinet and the bottom wall of the cabinet. Air is therefore not drawn towards the second one of the access apertures, thus reducing air flow in the region of the second one of the access apertures.

Optionally, one or more of the inlet apertures are located in a sidewall arranged along one of the opposing sides, the side wall being arranged to separate the air movement means from the internal space such that, in use, the air movement means draw air from the first one of the access apertures to that one of the opposing sides and thereafter through the inlet apertures. In some embodiments, all of the inlet apertures are located in a sidewall arranged along one of the opposing side.

Optionally, each of the opposing sides is provided with its own respective side wall, the side walls being arranged to separate the air movement means from the internal space, wherein the inlet apertures are defined in the side walls such that, in use, the air movement means draw air from the first access aperture to the opposing sides and through the inlet apertures.

Optionally, the air movement means are further configured to reduce the circulation of air in the region of the second one of the access apertures.

Optionally, the air movement means are positioned adjacent a side wall of the cabinet and on the opposite side of the side wall to the interior space of the cabinet.

Optionally, the air movement means comprises a first air movement device and a second air movement device each positioned adjacent a respective one of the side walls of the cabinet and on an opposite side of that respective side wall to the interior space of the cabinet. In this way, air is drawn to both of the opposing sides, thus distributing the air flow within the interior space and helping to keep conditions relatively uniform over a wider volume. Thus, positioning of a hot food item within the cabinet has less of an impact on the final quality of the food item.

Optionally, the cabinet further includes a chamber located within the cabinet and either above or below the interior space which, in use, receives heated air from the air movement means. The chamber may be provided with slots positioned above the first one of the access apertures, wherein the slots are configured to direct heated air from the chamber across said first one of the access apertures to form the air curtain. Such slots may extend substantially across the width of the chamber. It will thus be appreciated that each slot can create an air curtain that extends substantially fully across the first one of the access apertures of the cabinet.

Optionally, the chamber further includes airflow direction means arranged to direct air received from the air movement means to the slot.

In some embodiments, the door is movably mounted to one of the top, the base or one or both of the opposing sides of the cabinet. Optionally, the door is arranged to move between a first position in which the second one of the access aperture is substantially uncovered and a second position in which at least a portion of the second one of the access apertures is covered to prevent ambient air from entering the interior space and heated air from egressing the interior space through said second one of the access apertures.

In some embodiments the door is a hinged door. For example, the door may be pivotably mounted to one of the top, the base or one or both of the opposing sides of the cabinet. In some embodiments, the door is pivotably mounted to the top of the cabinet. The door may therefore close automatically under the action of gravity without requiring an operator to actively close the door once a food item has been placed into the interior space. Unlike in known cabinets, such as that disclosed in EP 3804575, because in the cabinet of the present invention airflow is minimised in the region adjacent the second one of the access apertures a pivoting or hinged door can be used, as opposed to a sliding door. It will be appreciated that as a hinged door pivots from the open to the closed position and vice versa a portion of air is entrained by the door. Because the hot airflow generated by the air movement means generally avoids the second one of the access apertures, the hot airflow in the cabinet is not significantly disrupted by air entrained by the moving door and conditions in the internal space remain stable.

In other embodiments, the door may be slidably mounted over the second one of the access apertures such that the door can be reversibly moved between a first position in which the second one of the access apertures is substantially uncovered and a second position in which the second one of the access apertures is covered to substantially prevent ambient air from entering the interior space and heated air from egressing the interior space through said second one of the apertures.

The door may be operated manually by a user. Alternatively, the door may be operated automatically based on signals from a sensor, for instance and infrared sensor. For example, the cabinet may be provided with a passive infrared (PIR) sensor which detects and/or measures infrared light emitted by a nearby LED when reflected off an object close to the door. In this way the PIR sensor may detecting the motion or presence of the object, such as a hand, or food, near the second one of the apertures. Upon detecting the motion/presence of an object an the PIR sensor may send a signal to a controller which activates an opening mechanism to move the door to the first position in which the second one of the apertures is substantially uncovered.

In some embodiments, the door covers substantially an entirety of the second one of the access apertures in the second position. Accordingly, the amount of ambient air which is prevented from entering the interior space is maximised. Similarly, the amount of heated air which is prevented from egressing the interior space is maximised. Alternatively, the cabinet may be provided with a plurality of doors, for instance, two doors. Each door may have an open and a closed position. Together, the doors may cover substantially an entirety of the second one of the apertures when each is in its respective closed position.

In some embodiments, a first portion of the air heated by the air heating means is utilised to produce said air curtain and a further portion of the air heated by the air heating means is circulated within said interior space.

The air movement means may comprise an electrically operated fan. The air heating means may comprise an electrically operated heating element. The air movement means may be positioned behind a side wall of the cabinet. In such an embodiment the side wall may be provided with one or more apertures which allow fluid communication between the interior space of the cabinet and the air movement means.

The cabinet of the present invention may have a single fan and heating element behind each side wall of the cabinet. In an alternative embodiment of the present invention, there may be provided multiple fans and heating elements behind each side wall.

In a second aspect, the invention provides a modular storage unit for the temporary storage of a heated food item, the storage unit comprising a plurality of the cabinets described above, wherein the plurality of cabinets are configured to mutually interlock to assemble the modular storage unit.

Optionally, the cabinets comprise complementary slots and projections, the projections of one cabinet being configured to mutually interlock with the slots of an adjacent cabinet to thereby assemble the modular storage unit.

Optionally, the modular storage unit further includes a cover panel which is arranged to cover one or more of the air heating means and air movement means of two or more cabinets of the plurality of cabinets when the modular storage unit is assembled. Further optionally the cover panel is arranged to cover one or more of the air heating means and air movement means of every one of the plurality of cabinets which comprise the unit when the modular storage unit is assembled.

The cover panel provides protection for the air heating means and air movement means from damage from impact, moisture and/or foreign bodies. The use of a cover panel which is common to multiple of the cabinets in the unit facilitates easy assembly and disassembly of the storage unit.

Optionally, the storage unit further comprises a pedestal, the pedestal being arranged beneath the plurality of cabinets when the modular storage unit is assembled and configured to support the plurality of cabinets.

The pedestal acts to raise the cabinets above the ground for improved hygiene and more convenient access to the interior spaces of the cabinets for users.

Optionally, the pedestal may be configured to house a control unit in use. The control unit may be configured to control the operation of the storage unit. For instance, the control unit may be configured to control an operation of one or more of the air movement means and air heating means of the plurality of cabinets.

Optionally an interior space of the pedestal comprises a slidable drawer, the slidable drawer being configured to support the control unit to enable the control unit to be slid into and out of an interior space of the pedestal, the sliding drawer having a closed position in which the drawer is entirely received within the interior space of the pedestal thereby preventing access to said interior space of the pedestal. In this way, the sliding drawer permits easy access to the control unit for an operator.

Optionally, the drawer comprises a locking arrangement, the locking arrangement being configured to lock the slidable drawer in the closed position. This provides extra security and helps to prevent tampering with the control unit.

### BRIEF DESCRIPTION OF DRAWINGS

Embodiments of the present invention will now be described with reference to the accompanying drawings in which:

FIG. 1 is a perspective view from a first side of a cabinet according to the invention;

FIG. 2 is a perspective view from a side opposite the first side of the cabinet of FIG. 1;

FIG. 3 is a perspective view from the first side of the cabinet of FIG. 1 in a partially assembled state;

FIG. 4 is a perspective view from the side opposite the first side of the cabinet of FIG. 1 in a partially assembled state;

FIG. 5 is an end view of the cabinet of FIG. 1 from the first side;

FIG. 6 is a side view of the cabinet of FIG. 1;

FIG. 7 is a perspective view from the first side of the cabinet of FIG. 1 in a partially completed state with a top panel removed;

FIG. 8 is a perspective view from above of the cabinet of FIG. 1 in a partially completed state with a top panel removed;

FIG. 9 is a partially sectioned view taken from above of the cabinet of FIG. 1;

FIG. 10 is a partially sectioned perspective view of the cabinet of FIG. 1;

FIG. 11 is a perspective view of a modular storage unit according to an embodiment of the invention;

FIG. 12 is a partially exploded view of the modular storage unit of FIG. 11;

FIG. 13 is an enlarged view showing a connection between cabinets in the storage unit of FIG. 11;

FIG. 14 is a partially sectioned view of the storage unit of FIG. 11 in a partially assembled state;

FIG. 15 is a partially exploded view of the storage unit of FIG. 11 in a partially assembled state;

FIG. 16 is a perspective view of the cabinet of FIG. 11 in a partially assembled state;

FIG. 17 is an enlarged view showing a connection between cabinets in the storage unit of FIG. 11; and

FIG. 18 is a perspective view of an installation including a storage unit according to an embodiment of the invention.

### SPECIFIC DESCRIPTION

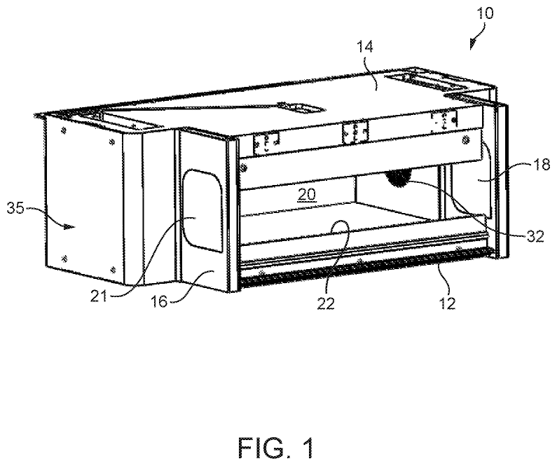

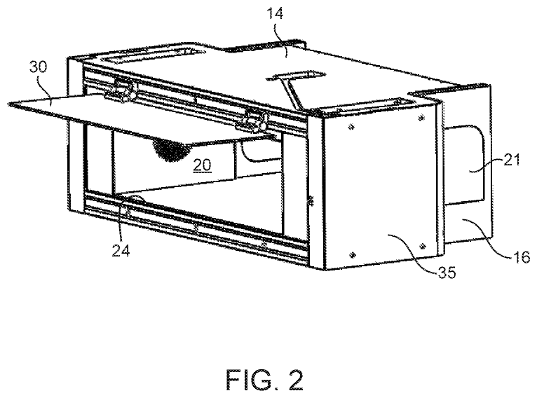

Referring initially to FIGS. 1 and 2 there is shown a cabinet, generally designated 10, which may be used for the temporary storage of a heated food item. As will be described in greater detail below, the cabinet 10 is intended to retard the cooling of heated food item before collection of the food item by a consumer or purchaser of the food item. The retarded cooling effect is achieved by the circulation of heated air over and around the food item.

The cabinet 10 includes a base 12, a top 14 and opposing side walls 16, 18. The base 12, top 14 and side walls 16,18 define an interior space 20 of the cabinet 10 which, in use, can temporarily accommodate a heated food item. The base 12, top 14 and side walls 16,18 further define opposing rectangular apertures 22,24 which, in use, allow a food item to be placed into and retrieved from the interior space 20. A first one of the apertures 22 is open to the environment. A door 30 is pivotably mounted to the top 14 and over the second aperture 24 via hinges 19 so as to substantially cover the aperture 24. The base 12, top 14, side walls 16,18 and door may be formed at least in part from a thermally insulating composite material.

A portion of each sidewall 16,18 toward the open aperture 22 is formed by a glazed panel 21. Cover panels 35 are arranged over the remaining portions of the side walls 16,18 located towards the door 30 and aperture 24. The cover panels 35 are affixed over the side walls 16,18 using threaded screws.

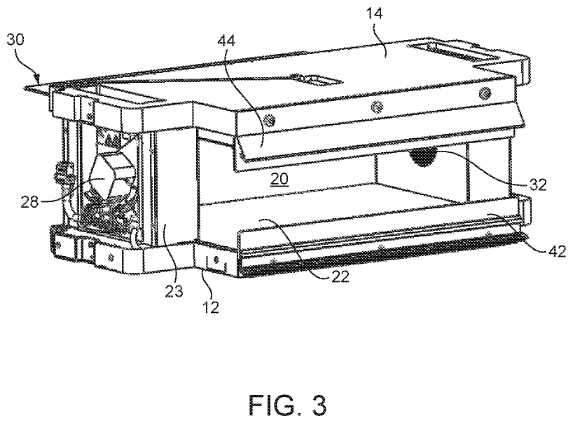

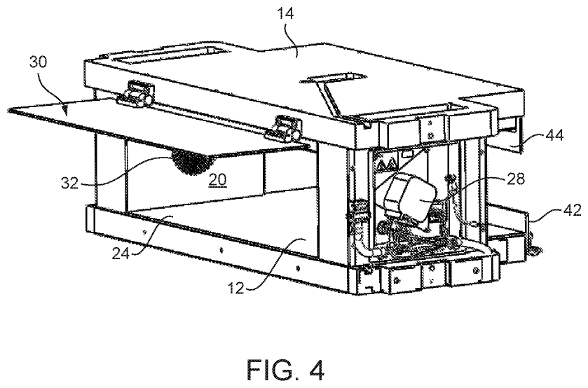

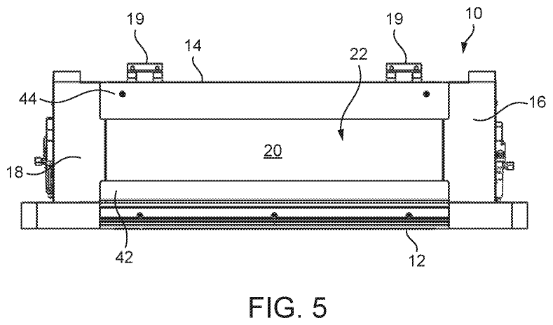

FIGS. 3 to 9 show the cabinet with the cover panels 35 and glazed panels 21 removed. Removing the cover panels 35 reveals electric fans 26,28 each within its own fan housing located adjacent each sidewall 16,18. The top, lower and side walls of the fan housings are defined by a frame 23 which generally describes a hollow open-ended cuboid. A heater element 31 is also provided in each fan housing. The heater elements may, for example, comprise electrically resistive heating elements which at least partially surround the fans 26,28. When assembled, the cover panels protect the fans 26,28 and other electrical components within the fan housings from the environment. The cover panels 35 may be removed by an operator to access the components within the fan housing.

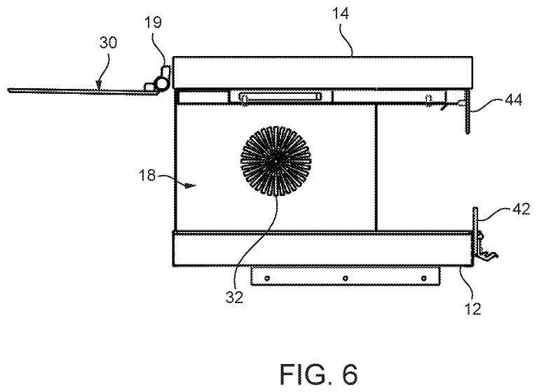

Referring now to FIG. 6, each sidewall 16,18 is provided with a plurality of inlet apertures 32 in a region of the sidewall 16,18 which adjoins the respective fan housing.

In use, the fans 26,28 are driven electrically and draw air from the interior space of cabinet 10 through the inlet apertures 32 an into the fan housings. Air drawn by each fan 26,28 through the inlet apertures 32 is heated by the heater elements 31. The fans 26,28 and heater elements may be operated to produce flows of air heated to a temperature of between 50 degrees Centigrade and 95 degrees Centigrade.

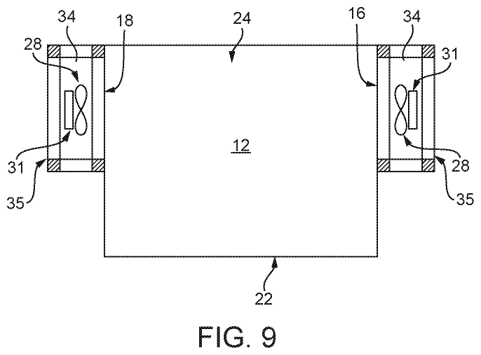

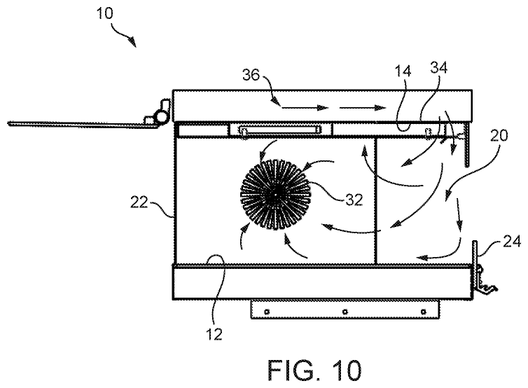

Referring now to FIGS. 9 and 10, the heated air is then delivered by each fan 26,28 through outlets 34 positioned above the interior of each fan housing. The outlets 34 communicate with a chamber 36 which is positioned above the interior space 20 of the cabinet 10.

The top 14 of the cabinet 10 is provided with a slot 38 which extends across the top 14 above the open aperture 22 of the cabinet 10. The slot 38 extends across substantially the whole width of the interior space 20 of the cabinet 10 and, in use, is used to form an air curtain across the open aperture 22.

Referring in particular to FIG. 10, air drawn from the interior space 20 of the cabinet 10 through the apertures 32 is heated and then delivered to the chamber 36 through the outlets 34. The heated air moves through the chamber 36 to the slots 38 whereupon it is directed downwardly through the slots 38 and across the cabinet aperture 22. A portion of the heated air directed through each slot 38 forms an air curtain across the aperture 22 while the remainder of the heated air circulates within the interior space 20 of the cabinet 10. Movement of the air within the cabinet as described above is indicated with arrows. As can be seen, a portion of the air delivered through each slot 38 forms an air curtain, while a second portion of the air delivered through each slot 38 circulates within the interior space 20 to heat the interior space 20. The fans 26,28 draw this latter portion of the air from the aperture 22 and towards the inlet apertures 32. Thus, airflow generally bypasses the second one of the access apertures.

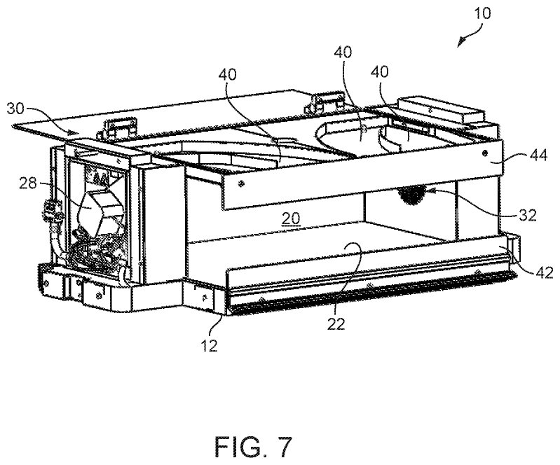

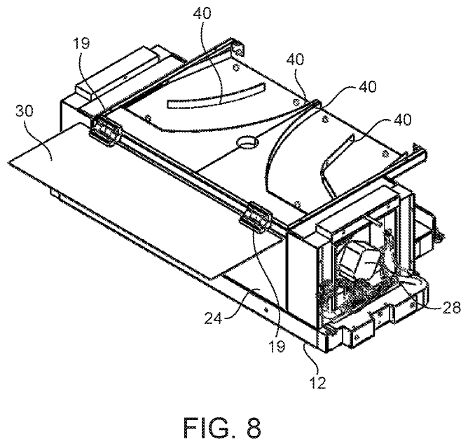

To assist with the movement of the heated air from the fan outlets 34 to the slots 38, the chamber 36 may be provided with one or more fins, vanes, baffles or other such airflow redirection means 40 as shown in FIGS. 7 and 8. The redirection means 40 ensure an evenly distributed flow of heated air from the fan outlets 34 to the slot 38. This in turn ensures uniformity of the air curtains formed across the aperture 22.

Referring to FIG. 3, each aperture 22,24 of the cabinet 10 is further provided with a weir 42 which extends across the lower edge of the aperture 22,24 between the side walls 16,18, and a deflector 44 which extends across the upper edge of the aperture 22,24 between the side walls 16,18. Each weir and deflector pair 42,44 acts to guide the air curtain across the aperture 22,24 with which they are associated.

In use, a kitchen worker may place cooked food through the aperture 24 by lifting the door 30. The door 30 will then swing shut under its own weight. Cooked food is then kept warm by circulation of the hot air inside the interior space 20 as described above. The hot air curtain also acts to retard cooling of the cooked food product by reducing ingress of cool air through the aperture 22.

The door 30 acts to further retard cooling of the cooked food by presenting a physical barrier to cool air from the ambient environment from entering the interior space 20. The door 30 also acts to the hot air being circulated within the interior space 20 from egressing through the aperture 24. In some embodiments, the door may be provided with a sealing strip, for instance, a strip of an elastomeric sealing material arranged along an edge of the door 30. The sealing strip may act to at least partially seal any gap between the door 30 and the base 12 and/or side walls 16,18 to thereby further inhibit any exchange between the hot airflow circulating in the interior space and an ambient airflow. In other embodiments, the sealing strip could be placed along an edge of the aperture 24, and therefore along an edge of one or more of the top 14, the base 12 or either of the sides 16,18.

The glazed panels 21 also provide a physical barrier to the exchange of heated air inside the cabinet and cool air in the environment, whilst allowing purchasers or consumers to view the heated goods therethrough.

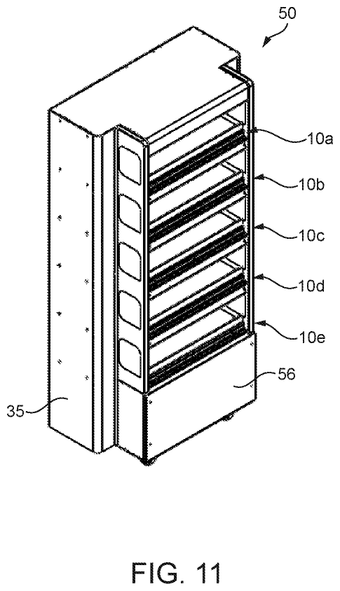

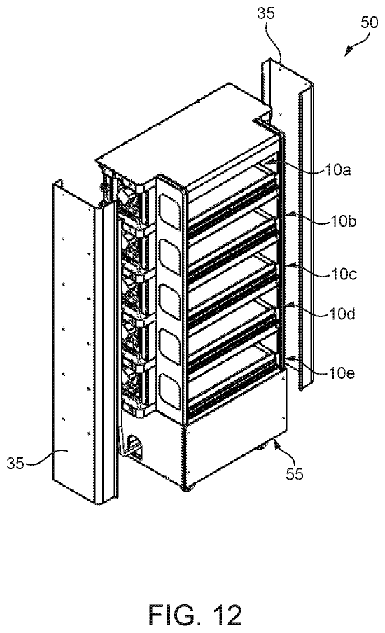

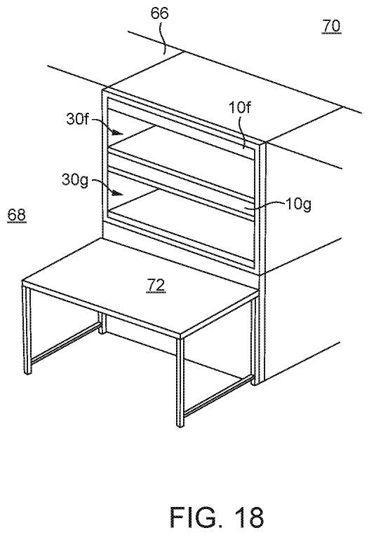

Referring to FIGS. 11 to 18, there is a shown a modular storage unit 50 comprising: 5 stacked cabinets 10a-e; a top panel 52; cover panels 35 and glazed panels 21 arranged on either side of the unit 50; and a pedestal 54. The pedestal 54 is supported on 4 wheels 55 so that the cabinet 50 can be easily moved.

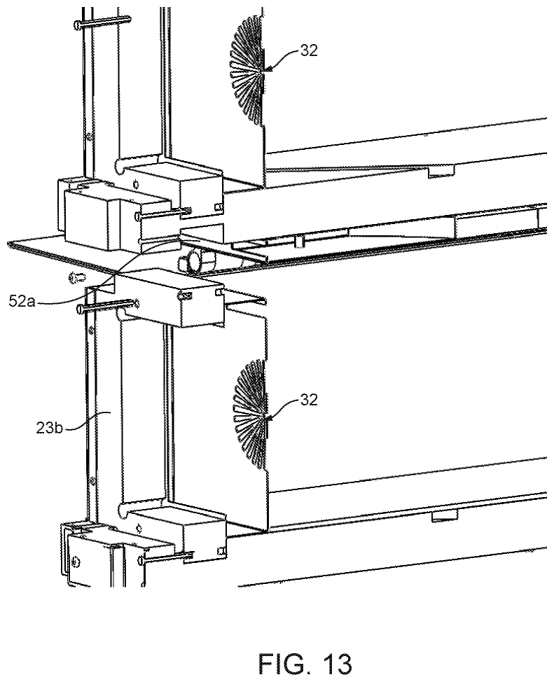

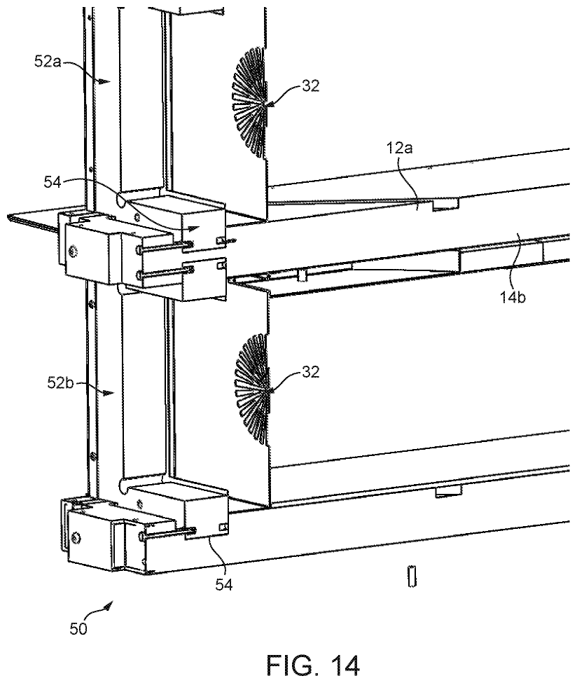

In this embodiment, the unit 50 is a 5-tiered unit comprising 5 stacked cabinets 10a-e. It will be understood that the invention is not limited to 5-tiered units and that the unit may instead include any number of tiers, and thus cabinets. For instance, 3-tiered units and 4 tiered-units are equally conceivable. Each cabinet 10a-e in the unit corresponds substantially to the cabinet 10 described in connection with FIGS. 1 to 10, and like reference numerals are used to designate like cabinet features. Each cabinet is designated with a suffix a to e according to the order in which the cabinets 10a-e are stacked, with cabinet 10a being the top cabinet in the stack and cabinet 10e being the bottom cabinet in the stack. As can be seen in FIGS. 13 and 14, the cabinets 10a-e are arranged in the stack such that the respective base 12a-d of each of the upper four cabinets 10 a-d faces the top 14b-e of the cabinet directly below it in the stack.

The unit 50 comprises 2 cover panels 35 arranged on either side of the unit 50. Each cover panel 35 extends the height of the unit 50 and thus acts as a common cover panel 35 to all cabinets 10a-e in the stack. As described in connection with the singular cabinet of FIGS. 1 to 10, the cover panels 35 are installed over the fans 26a-e, 28a-e of each of the cabinets 10a-e and serve to protect the fans 26a-e,28a-e, and other electronic components within the respective fan housings, from the environment.

The unit 50 also comprises 2 glazed panels 21 arranged on either side of the unit 50. Each glazed panel 21 extends the height of the unit 50 and comprises 5 glazed windows which register with the internal spaces 20a-e of the cabinets 10a-e such that purchasers/consumers may view the heated food whilst it is kept warm. To this end, the interior space may also be provided with a lighting system configured to illuminate the interior space and thereby allow the interior space 20 to be viewed through the glazed panels 21.

The pedestal 56 is arranged underneath the bottom cabinet 10e in the stack and acts to support the stack of cabinets 10a-e, as well as raise it above the ground for improved hygiene and convenience in accessing the cabinets 10a-e. The pedestal 54 comprises 5 panels arranged at right-angles to each other so as to define an open-topped hollow cuboid with a hollow interior.

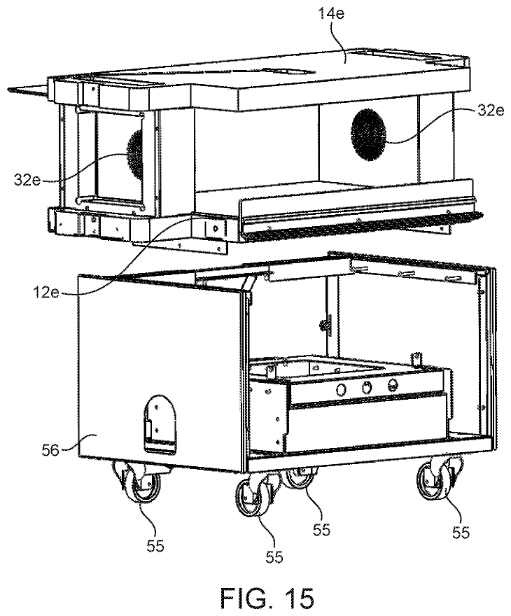

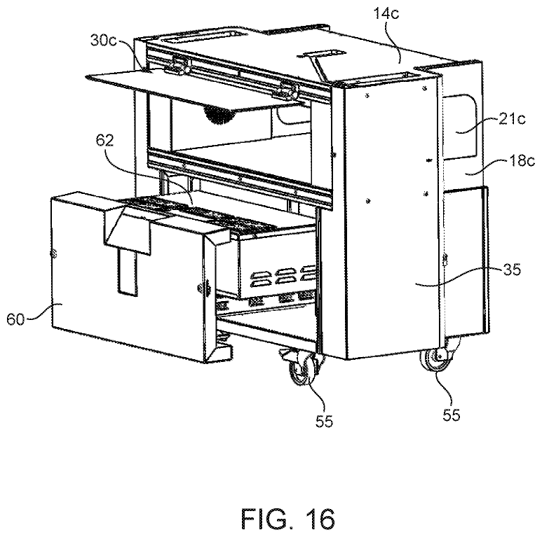

FIG. 15 shows the pedestal 54 with a front panel removed and prior to installation of a sliding drawer 60 which will be described in more detail in connection with FIG. 16. It can be seen that the pedestal 54 comprises a hollow interior. The hollow interior of the pedestal may be used to house electronic components such as wires which connect the electronic components in each of the fan housings to a power source. The hollow interior of the pedestal may be used to house electronic components such as wires which connect the electronic components in each of the fan housings to a power source.

Referring to FIG. 16, in this embodiment, the pedestal 54 comprises a sliding drawer arrangement 60 in the hollow interior. The sliding drawer arrangement 60 comprises a frame 72 having a plurality of rollers 74. The rollers 74 may be substituted for PTFE strips or a low friction coating. The rollers 74 support the sliding drawer 64 so that it can slide relative to the hollow interior of the pedestal. The sliding drawer 64 supports a control unit 62. The control unit 62 can be used to control various operations of each of the cabinet. For instance, the control unit 62 may be configured to control the operation of the unit 50. In particular, the control unit 62 may be configured to control the operation of each of the various cabinets 10a-e individually.

In some embodiments, the unit 50 may also comprise a user interface which allows a user to input instructions to the control unit 62. The instructions may, for instance, involve information indicating that the fans 26,28a-e and/or heating elements 31a-e of certain cabinets 10a-e in the stack should be operated to circulate warm air within the cabinet as described above. The instructions may also involve information indicating a desired the temperature of the interior space 20a-e of a given cabinet. Upon receiving information related to the temperature of the interior space 20a-e, the control unit 62 may adjust the power delivered to the heating elements 31a-e in order to adjust the temperature of the interior space to the desired level. The instructions may also relate to the speed of the fans 26,28 of a given cabinet 10a-e. The instructions may also involve information indicating that a lighting system in a given cabinet 10a-e should be switched on or off.

Referring now to FIGS. 13 and 14, the assembly of the cabinets 10a-e within the unit 50 will be described. As described above in connection with FIGS. 1 to 7, each cabinet 10a-e is provided with a frame 23a-e comprising four linear sections joined at right angles so as to generally describe the four longitudinal sides of a cuboidal prism. Each side wall 16a-e, 18a-e of a given cabinet 10a-e in the stack is provided with a frame 23a-e arranged so that an open longitudinal end of the prism described by the frame 23a-e faces and engages the portion of the respective sidewall 16a-e, 18a-e provided with inlet apertures 32a-e. In this way, the frames 23a-e form top, lower and side walls for the fan housings which communicate with the interior spaces 20a-e via the inlet apertures 32a-e.

In the cabinets 10a-e of the modular storage unit 50, each of the upper and lower surfaces of the frame 23b-e is provided with a projection 56a-e which extends along a portion of the length of said upper or lower surface. The projection may, for example be formed by taking cuboidal cut-outs from the corners of the frame such that a mid-portion along the length of each of the linear sections forming a given frame protrudes out above the corner portions to define projections 56a-e.

Slots 58a-d are arranged on opposing upper and lower surfaces of each of the bases 12a-d of the 4 cabinets 10b-e intended to be arranged as the top four tiers of the stack. The slots 58a-e are complementary in shape to the projections 56a-e and are located on each base 12a-e so as to register with a corresponding projection 56a-e when the cabinets 10a-e are stacked. On the other hand, only the upper surface of the base 12a of the cabinet 10e intended to be arranged as the lower-most tier in the stack is provided with slots 58e.

A given cabinet 10a-e is then assembled by engaging the projections 56a-e on the lower surface of the frame with the corresponding slots 58a-e on the upper surface of the bases 12 a-e. The tops 14a-e of the cabinets 10a-e are then installed on the frames 23a-e such that the projections 56a-e on the upper surfaces of the frames 23a-e protrude above the tops 14a-e of the cabinet 10a-e. In this way, the stack of cabinets can then be assembled by stacking the cabinets 10a-e such that the projections 10b-e on the upper surfaces of the frames 23b-e of each of the top 4 cabinets engage in the slots 58a-d on the lower surface of the base 12a-d directly above it in the stack.

It will be understood that only the cabinets which will sit above another cabinet in the stack (in this embodiment, the upper four cabinets) which need be provided with slots on the lower surface of the base. Thus, it would usually only be the bottom-most cabinet in the stack which is not provided with slots on the lower surface of the base Thus, in a four-tiered unit, it is the upper three cabinets in the stack which would be provided with slots on the lower surface of the base. In a three-tiered unit it is the upper two cabinets which would be provided with slots on the lower surface of the base.

Of course, it is not necessary that the projections of one cabinet must be arranged to engage with the slots of a cabinet sitting directly above. In other embodiments, the slots and the projections may be reversed such that the lower surface of the base of one cabinet is provided with projections which engage with slots arranged on an upper surface of a cabinet intended to sit directly beneath in the stack. In some embodiments, the lower surface of the base of one cabinet may be provided with a combination of projections and slots designed to engage with complementary slots and projections on an upper surface of a cabinet intended to sit directly beneath in the stack.

Referring to FIG. 15, the assembly of the stack of cabinets 10 a-e on the pedestal 54 will now be described.

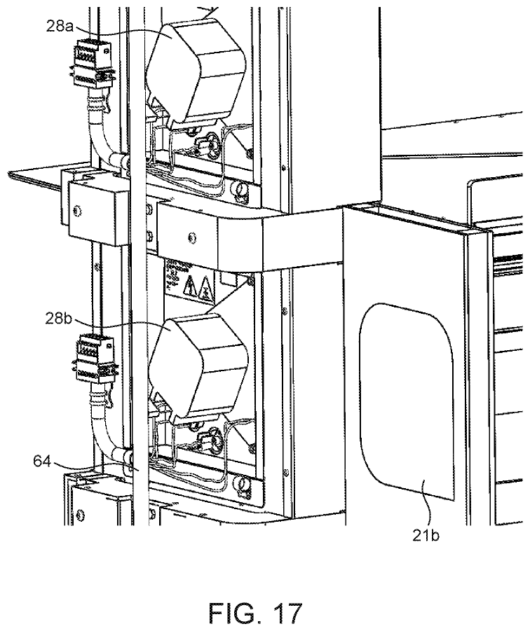

Once the cabinets are assembled in the stacked configuration with the projections engaged and mutually interlocked in the complementary slots, the cabinets are bolted in place. Subsequently, the fans 26,28 and other electronic components are assembled within the fan housings. Wire harnesses 60 are then installed on each side of the unit over the fans 26,28 so as to link the cabinets together, as shown in FIG. 17.

In use, the unit 50 may be installed incorporated into a wall or partition 66 which divides a food preparation area 68 from a food collection area 70. In the embodiment shown, the unit 50 is a two-tiered unit 50 including two stacked cabinets 10. A food preparation and packaging table 72 is provided adjacent the doors 30 and cabinet apertures 24 on the food preparation area 68 side of the wall 52. It will be understood that cooked food products can be removed from an oven and packaged on the table 72 before being placed in the cabinets 10. The cooked and packaged food products can thereafter be removed via the cabinet apertures 22 on the opposing side of the wall 66 to the food preparation area 68.

Referring to FIG. 188, the present invention thus provides a cabinet 10 which is open at a first end and closed by a door at an opposing end and which can be operated so as to provide an interior space 20 which can be maintained at an elevated temperature, for example between 50 and 90 degrees centigrade. The interior space 20 is accessible though the apertures 22,24 for the purpose of inserting and removing heated food items. The air curtain act to maintain the interior space 20 of the cabinet 10 at the required elevated temperature while providing minimal impedance to the removal of heated food items.

A cabinet 10 in accordance with the present invention may be used in conjunction with the temporary storage of packaged baked goods such as pizzas and flatbreads.

The cabinet 10 may advantageously be placed at a location between where such packaged baked goods are prepared and then collected by a purchaser or consumer. The baked goods may be removed from the oven in which they have been prepared and placed in an appropriately configured package. The package is then placed into the interior space 20 of the cabinet 10 through an aperture which faces the preparation location.

The heated air circulating within the interior space 20 acts to retard the cooling of the baked goods prior to the package being removed by a purchaser or consumer of the baked goods through the other of the cabinet apertures.

A plurality of such cabinets 10 may be provided one on top of another in a modular storage unit according to the invention. In this way, the invention provides multiple locations where packaged baked goods may be temporarily stored before collection.

Degradation of the quality of the baked goods is minimised while within the interior space 20 of the cabinet 10 as the package is not exposed to a directly heated surface such as, for example, an electrically heated hot plate. The cabinet 10 of the present invention is not limited for use with packaged baked goods, and may be used in conjunction with any heated food item. It will be understood that the cabinet of the present invention is not intended to heat or cook the food items placed within the interior space 20 but instead is intended to retard the cooling of already heated food items.

1. A cabinet for the temporary storage of a heated food item, the cabinet having a base, a top and opposing sides, wherein the base, top and opposing sides define an interior space which is accessible through opposing access apertures at each end of the cabinet and wherein the cabinet is provided with air movement means and air heating means operable to draw air from the interior space of the cabinet, heat said air and utilise said heated air to produce an air curtain across a first one of the access apertures of the cabinet, the cabinet further comprising a door, the door being operable to reversibly close a second one of the access apertures to prevent ambient air from entering the interior space and heated air from egressing through said second one of the access apertures, wherein the air movement means are configured to circulate air within the interior space from the first one of the access apertures to one or more of: the opposing sides, and the top and the base of the cabinet.

2. A cabinet according to claim 1, further wherein the air movement means are configured such that air circulating within the interior space from the first one of the apertures to the one or more of the opposing sides, and the top and the base of the cabinet bypasses a region adjacent the second one of the access apertures.

3. A cabinet according to claim 1, wherein the cabinet is provided with one or more inlet apertures which allow fluid communication between the interior space of the cabinet and the air movement means, further wherein the one or more inlet apertures are spaced from the second one of the access apertures.

4. A cabinet according to claim 3, wherein one or more of the inlet apertures are located in a side wall arranged along one of the opposing sides, the side wall being arranged to separate the air movement means from the interior space such that, in use, the air movement means draw air from the interior space through the inlet apertures in a sidewall.

5. A cabinet according to claim 4, wherein each of the opposing sides is provided with its own respective side wall, the side walls being arranged to separate the air movement means from the interior space, wherein the inlet apertures are defined in the side walls such that, in use, the air movement means draw air from the interior space through the inlet apertures.

6. A cabinet according to claim 5, wherein the air movement means comprises a first air movement device and a second air movement device each positioned adjacent a respective one of the side walls of the cabinet and on an opposite side of that respective side wall to the interior space of the cabinet.

7. A cabinet according to claim 1, wherein the air movement means are further configured to reduce the circulation of air in a region of the second one of the access apertures.

8. A cabinet according to claim 1, further including a chamber located within the cabinet and either above or below the interior space which, in use, receives heated air from the air movement means.

9. A cabinet according to claim 8, wherein the chamber includes a slot positioned above the first one of the access apertures, said slot being configured to direct heated air from the chamber across said first one of access apertures to form the air curtain.

10. A cabinet according to claim 9, wherein the chamber further includes airflow direction means arranged to direct air received from the air movement means to the slot.

11. A cabinet according to claim 1, wherein the air movement means are configured such that, in use, air flow in the interior space is at a minimum in a region adjacent the second one of the access apertures.

12. A cabinet according to claim 1, wherein the door comprises a hinged door.

13. A cabinet according to claim 12, wherein the door is pivotably mounted to the top of the cabinet.

14. A cabinet according to claim 1 wherein a first portion of the air heated by the air heating means is utilised to produce said air curtain and a further portion of the air heated by the air heating means is circulated within said interior space.

15. A cabinet according to claim 1, wherein the air movement means comprise an electrically operated fan.

16. A cabinet according to claim 1, wherein the air heating means comprise an electrically operated heating element.

17. A modular storage unit for the temporary storage of a heated food item, the storage unit comprising a plurality of cabinets according to claim 1, wherein the plurality of cabinets are configured to mutually interlock to assemble the modular storage unit.

18. A modular storage unit according to claim 17, wherein the cabinets comprise complementary recesses and projections, the projections of one cabinet being configured to mutually interlock with the complementary recesses of an adjacent cabinet to thereby assemble the modular storage unit.
